(19) United States
(12) Patent Application Publication
(10) Pub. No.: US 2006/0260636 A1
(43) Pub. Date: Nov. 23, 2006

(54) Oral hygiene apparatus (floss)

(76) Inventor: Kye Young Lee, Monterey Park, CA (US)

Correspondence Address: Kye Young Lee, 1809 Wilcox Ave. #B, Monterey Park, CA, 91755, US

(21) Appl. No.: 10/962,322

(22) Filed: May 19, 2005

(51) Int. Cl. A61C 15/00

(52) U.S. Cl. 132/325

(57) ABSTRACT

The composition and characteristics of this device is as follows; 01. This device is composed of a main frame of case shape with a dental floss roll built in the inside of cylinder. 02. A symmetrical cap linking with connecting groove. 03. A dental floss roll is built in a quadrangular pole to which elastic pin is attached. 04. It provides for dental floss toward the outside elastically.

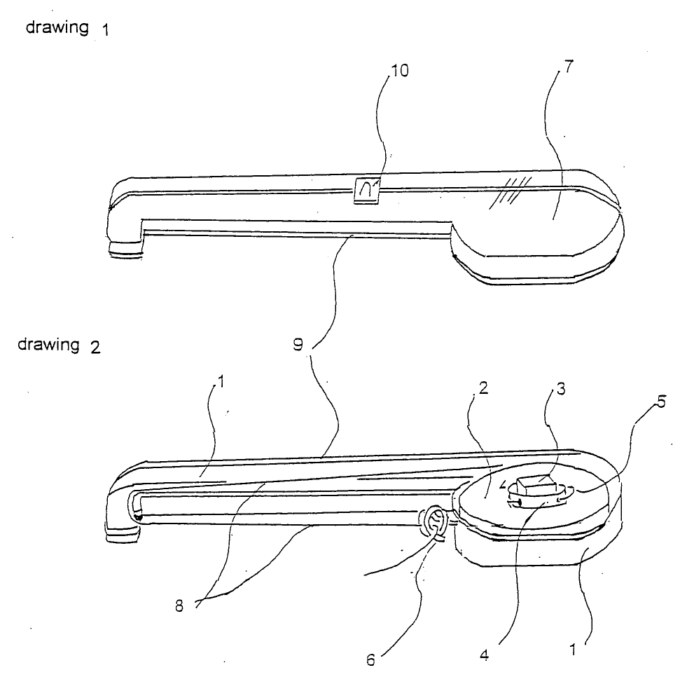

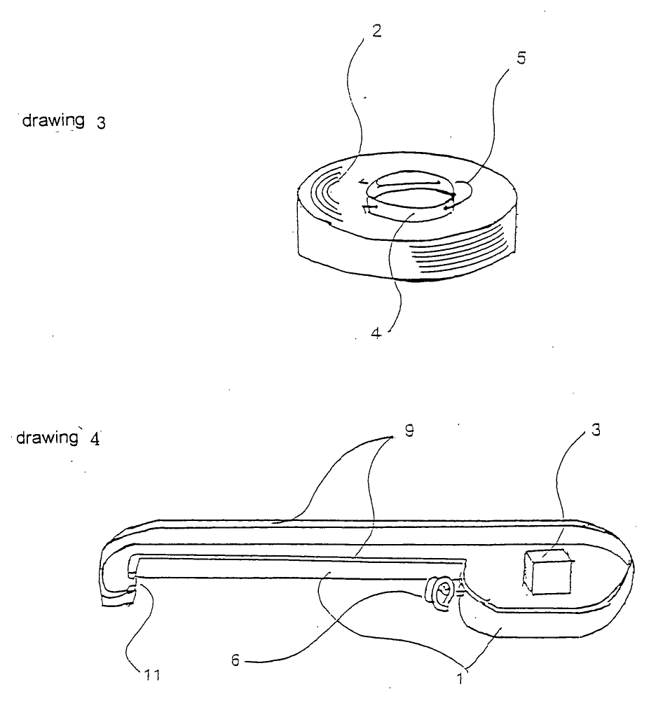

### BRIEF EXPLANATION OF THE DRAWINGS

<Drawing 1>: Side view of cap linked to main frame (Drawing 2)

<Drawing 2>: Side view of main frame of this device

<Drawing 3>: Enlarged side view of floss roll separated from main frame (Drawing 2)

<Drawing 4>: Side view of main frame with floss roll detached

### MAIN DRAWING

### Drawing 2

Specification:
01. Dental flossing has been used to clean debris between teeth which is not removed by regular tooth-brushing,
02. But this method is too inconvenient because it is hard to insert dental floss between teeth with 4 fingers in the mouth.
03. Some improved devices are in the market for sale,
04. But they are not efficient because floss is too short,
05. They are not economical and polluting environment because wasting is too much.
06. This device has been improved on these problems and its structure and function are as follows;
07. It is composed of a round part which man can grip with hand and
08. A pole/stick part.
09. Two parts is united by connecting groove(9)
10. Accompanying cap(7), inside of main frame(1), dental floss roll(2) linked to quadrangular pole(3)
11. Pull the floss hard from outside, then
12. Floss rolls sitting on the quadrangular pole starts to rotate.
13. At the moment and 45 degree when the pin attached to quadrangular pole(3) goes over the corner of the pole, it opens to the maximum extent and
14. At the moment of 90 degree, it returns to normal position.
15. Through repetition of this operation which is being attached to face of pole:
16. Floss is reeled off by strong power and stops at weak power. In this way, it has an intermittent elasticity.
17. When the end of floss is inserted into dental floss holder(6) from outside in a very tense state,
18. The floss between outlet of floss(11) and dental floss holder(6)
19. Can be maintained as tight as a bowstring.
20. Man holds the handle(cylinder) in his hand and insert the bowstring between teeth,
21. By moving forward and backward, up and down,
22. Man can easily and hygienically clean debris between teeth

### DESCRIPTION OF THE INVENTION

Idea of this invention is to make an apparatus that can easily and conveniently floss without force or waste. As shown in the drawing, a plastic frame (part 1) has a square hub (part 2) adhered to the center. Floss roll (part 3) with metal string pin (part 4) is installed to the square hub. Pull out the string of floss inside of the frame and then join the frame with the cap (part 7). Pull string of floss and insert it in the holder ring (part 5) and make it taut, then cut the rest of the string in the cutter (part 6). Insert the taut string of floss between teeth and clean by pushing back and forth.

Process of Making

This apparatus is a combination of parts existent in today's market, parts derived from such parts and newly produced to make an apparatus for easier and effective flossing. Two separate sheets of drawing and description of its parts are below.

Frame (part 1): round part of the frame with a square hub of 10 mm in the center with measurements of diameter 12 cm, height 1.2 cm, and wall thickness 2 mm. With bottom wall thickness of 1 mm, this frame is made of plastic and can be easily ordered and made by plastic manufacturer and holes to install the pin (part 5) is part of the frame design.

Hub (part 2): adhered to the frame (part 1) with thickness of 1 mm, it is square hub where pin (part 4) would be installed allowing roll (part 3) to rotate in 90 degree motion for every push.

Roll (part 3): similar to the roll of floss seen on similar products on the market, one side of the plastic pipe (part 8) that holds the floss roll would have enough space for 4 (four) holes for pin (part 4) installation.

Pin (part 4): it is made of a metal string that has tension and resilience equivalent to the third string of the guitar. With “U” form, this metal string pin has inside diameter of 10.1 mm and is adhered to the square hub (part 2) so that it aids the roll to have a controlled push and stop.

Holder Ring (part 5): similar to a key ring. It is made of a double fold metal ring that you can insert the floss string to keep it taut.

Cutter (part 6): similar to the items seen on the market, it is installed on the frame with enough distance to have string to pull for next cut.

Cap (part 7): symmetrical to the main frame, a groove is put into the portion where the two parts meet so that when cap is closed, it is tightly fitted and adhered to the main frame.

Roll pipe (part 8): with thickness of 1 mm and inside diameter of 13.1 mm, there must be space of 2 mm to install the pin (part 4).

Measurements indicated in the drawings are not final and can be altered in the process of manufacture if needed.

Process of Using

Roll of floss inserted inside the frame rolls out when pulling the floss string outside of the Flossibow and then insert the floss string in the holder making it taut, then cut the rest of the floss string in the cutter. Hold the main part of the frame (round part) and insert the taut floss string between the teeth. Clean effectively be pulling and back and forth.

### Additional Explanation

<1. main frame>: A square pole(3) is fixed in the center of store chamber inside the hand-held cylinder part and a connecting groove(9) is reserved for uniting with the cap(7). This device can be manufactured in the same manner as the existing method of plastic projection.
<2. Dental floss roll>: Floss coiled on the plastic pipe(4) which people can find in the existing products in the market.
<3. Square pole>: A square pole fixed in the dead center of store chamber of the main frame(1) which is linked to elastic pin(5) and gives elasticity to the floss roll.
<4. Roll pipe>: A plastic pipe on which floss is coiled. Elastic pin(5) can be linked to the square pole. Some allowance is given to the side end of the pipe on which floss is coiled for 4 holes to be arranged at proper intervals.
<5. Elastic pin>: A steel line of high elasticity is built in to the hole of pipe(4) and attached to the face of square pole.
<6. Holde ring>: A steel ring(chain) of the same material as key chains keeps floss in good tension by fixing the floss end coming out of floss exit(1).
<7. Cap>: A cap which can be linked to the main frame through the connecting grove.
<8. Tooth-brushing floss>: Thread being unrolled from the floss roll is linked to the fixed ring to keep its tension like a bow string and remove debris between teeth. People can find it in the market.
<9. Connecting groove>: A groove located at the end of the device which connects firmly the main frame(1) and the cap(7) to keep the device beautiful.
<10. Cutter>: A cutting device attached to the upper central part of the cap which can cut the floss with a little allowance remained for the next cutting on the fixed ring(6). People can find it in the market.

1. Composed of cylinder part which man can grip with hand, main frame on stick part and symmetrical cap which borders on each other

2. This oral hygiene apparatus of case form,

3. The elastic pins attached to 4 holes on the side end of pipe on which floss is coiled and

4. Dental floss roll mounted on square pole which is attached to the elastic pin

5. A bundle of components like store case in which dental floss is built.

6. All of the assembly parts being used for dental flossing.

7. An exclusive monopoly patent for all of these is claimed.
